(19) United States
(12) Patent Application Publication
(10) Pub. No.: US 2026/0159400 A1
(43) Pub. Date: Jun. 11, 2026

(54) X-HYDRIDE MAX PHASE AND MXENES

(71) Applicants: Drexel University, Philadelphia, PA (US); Y-Carbon Ltd., Kyiv (UA)

(72) Inventors: Yury Gogotsi, Ivyland, PA (US); Oleksiy Gogotsi, Kyiv (UA); Iryna Roslyk, Elmer, NJ (US); Veronika Zahorodna, Mankivka (UA); Ivan Baginskiy, Kyiv (UA); Robert Lord, Chandler, AZ (US)

(21) Appl. No.: 19/407,609

(22) Filed: Dec. 3, 2025

Related U.S. Application Data
(60) Provisional application No. 63/728,737, filed on Dec. 6, 2024.

(51) Int. Cl. C01B 32/90; C01B 6/00

(52) U.S. Cl. CPC C01B 32/90; C01B 6/003; C01P 2002/72; C01P 2002/77; C01P 2002/84; C01P 2002/89; C01P 2004/03; C01P 2004/04

(57) ABSTRACT

A x-hydride MXene, comprising: a MXene material, the MXene material having the formula Mₙ₊₁(XH)ₙTₓ, wherein M is an early transition metal, X is C and/or N, and T is a surface termination. A composition, comprising: a MAX-phase material, the MAX-phase material comprising an amount of hydrogen therein. A method for forming a x-hydride MXene, comprising: removing the A-element from a MAX-phase material that comprises an amount of hydrogen therein, the removing being performed under conditions sufficient to give rise to an x-hydride MXene.

### RELATED APPLICATIONS

The present application claims priority to and the benefit of U.S. patent application Ser. No. 63/728,737, “X-Hydride MAX Phase And MXenes” (filed Dec. 6, 2024). All foregoing applications are incorporated herein by reference in their entireties for any and all purposes.

### GOVERNMENT RIGHTS

This invention was made with government support under Contract No. DE-SC0018618 awarded by the United States Department of Energy. The government has certain rights in the invention.

### TECHNICAL FIELD

The present disclosure relates to the field of MXene materials and also to the field of MAX phase materials.

### BACKGROUND

MXene materials exhibit a range of useful properties. Accordingly, there is a long-felt need for additional MXene materials.

### SUMMARY

In meeting the described long-felt needs, the present disclosure provides a x-hydride MXene, comprising: a MXene material, the MXene material having the formula Mₙ₊₁(XH)ₙTₓ, wherein M is an early transition metal, X is C and/or N, and T is a surface termination.

Also provided is a composition, comprising: a MAX-phase material, the MAX-phase material comprising an amount of hydrogen therein.

Further provide is a method for forming a x-hydride MXene, comprising:
removing the A-element from a MAX-phase material that comprises an amount of hydrogen therein, the removing being performed under conditions sufficient to give rise to an x-hydride MXene.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1. Schematic of Ti₃AlC₂ synthesis.

FIG. 2. Yield and lattice parameters of Ti₃AlC₂ (TiH₂)

FIG. 3. Characterization of MAX phases: XRD patterns and SEM image of Ti₃AlC₂ (TiH₂)

FIG. 4. XRD Sl-Ti₃C₂Tₓ produced with Ti sponge, TiH₂/Tisp and TiH₂

FIG. 5. AFM images and flake size distributions of delaminated Ti₃C₂Tₓ produced with TiH_{2,} Ti sponge and TiH₂/Tisp

FIG. 6. SIMS of Ti₃AlC₂ (a) TiH₂, (b) TiH₂/TiSp

FIG. 7. SIMS of Ti₃C₂ (a) TiH₂, (b) TiH₂/TiSp

FIG. 8. Spectra from 2 spots on each sample (labeled *_1 and *_2)

FIG. 9. Peak analysis: intensity (a) and position (b)

FIG. 10. Sintered pellets after MAX synthesis. (a) TiH₂ /Tisp, (b) TiH₂ and (c) Ti sponge powders.

FIG. 11. UV-vis spectra of delaminated Ti₃C₂T_{X} produced from MAX phases obtained by TiH₂, TiH₂/Tisp and Ti sponge powders.

FIG. 12 provides exemplary secondary ion mass spectroscopy (SIMS) data that show the presence and location of hydrogen; the SIMS results are for V2AlC (V2C) with vanadium hydride.

Table 1. Exemplary raw powders.
Table 2. Lattice parameters of different MAX-phase materials.
Table 3. Conductivity of various MXene films.
Table 4. Density and porosity of Ti₃AlC₂.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise. Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4.

Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Any embodiment or aspect provided herein is illustrative only and does not limit the scope of the present disclosure or the appended claims. Any part or parts of any one or more embodiments or aspects can be combined with any part or parts of any one or more other embodiments or aspects.

Among vast variety of two-dimensional (2D) materials, MXenes, discovered in 2011 at Drexel University, have made significant progress as evidenced by the many publications in recent years. MXenes are two-dimensional transition metal carbides and/or nitrides with a composition of Mₙ₊₁XₙTₓ, where M can be an early transition metal (Ti, V, Nb, Mo, and the like), X is C and/or N, n can be 1-5, and Tₓ stands for surface terminations, mainly including —O, —OH, and —F. Unique properties of these materials such as high electrical conductivity, specific electromagnetic and optic properties, tunable surface chemistry make them attractive for numerous applications.

To date, numerous MXene compositions have been reported. The majority of them are carbides. However, due to occupation of X sites by nitrogen, or both carbon and nitrogen, one can obtain nitrides (Ti₂NTₓ) or carbonitride (Ti₃CNTₓ). Studies using secondary-ion mass spectrometry (SIMS) techniques detected oxygen which substituted carbon/nitrogen in the X sublattice and such MXenes were suggested to be called oxicarbide, oxynitride, and oxycarbonitride.

These compositions are also sometimes described in terms of the phrase “MX-enes” or “MX-ene compositions.” MXenes may be described as a two-dimensional transition metal carbide, nitride, or carbonitrides comprising at least one layer having first and second surfaces, each layer comprising:
a substantially two-dimensional array of crystal cells,
each crystal cell having an empirical formula of Mₙ₊₁Xₙ, such that each X is positioned within an octahedral array of M,
wherein M is at least one Group IIIB, IVB, VB, or VIB metal,
wherein each X is C, N, or a combination thereof, preferably C;
n=1-5, preferably 1, 2, or 3.

These so-called MXene compositions have been described in U.S. Pat. No. 9,193,595 and Application PCT/US 2015/051588, filed Sep. 23, 2015, each of which is incorporated by reference herein in its entirety at least for its teaching of these compositions, their (electrical) properties, and their methods of making. That is, any such composition described in this patent is considered as applicable for use in the present methods and within the scope of the present invention. For the sake of completeness, M can be at least one of Sc, Y, Lu, Ti, Zr, Hf, V, Nb, Ta, Cr, Mo, or W. Certain of these compositions include those having one or more empirical formula wherein Mₙ₊₁Xₙ comprises Sc₂C, Ti₂C, V₂C, Cr₂C, Cr₂N, Zr₂C, Nb₂C, Hf₂C, Ti₃C₂, V₃C₂, Ta₃C₂, Ti.sub.4C₃, V.sub.4C₃, Ta.sub.4C₃, Sc₂N, Ti₂N, V₂N, Cr₂N, Cr₂N, Zr₂N, Nb₂N, Hf₂C, Ti₃N₂, V₃C₂, Ta₃C₂, Ti.sub.4N₃, V.sub.4C₃, Ta.sub.4₃ or a combination or mixture thereof. In particular embodiments, the Mₙ₊₁Xₙ structure comprises Ti₃C₂, Ti₂C, Ta.sub.4C₃ or (V.sub.1/2Cr.sub.1/3)₃C₃. In some embodiments, M is Ti or Ta, and n is 1, 2, or 3, for example having an empirical formula Ti₃C₂ or Ti₂C and wherein at least one of said surfaces of each layer has surface terminations comprising hydroxide, oxide, sub-oxide, or a combination thereof.

In some embodiments, a MXene can comprise a composition comprising at least one layer having first and second surfaces, each layer comprising:
a substantially two-dimensional array of crystal cells,
each crystal cell having an empirical formula of M′₂M″ₙXₙ₊₁, such that each X is positioned within an octahedral array of M′ and M″, and where M″ₙ are present as individual two-dimensional array of atoms intercalated (sandwiched) between a pair of two-dimensional arrays of M′ atoms,
wherein M′ and M″ are different Group IIIB, IVB, VB, or VIB metals (especially where M′ and M″ are Ti, V, Nb, Ta, Cr, Mo, or a combination thereof),
wherein each X is C, N, or a combination thereof, preferably C; and
n=1 or 2.

These compositions are described in international patent application PCT/US 2016/028354, filed Apr. 20, 2016, which is incorporated by reference herein in its entirety at least for its teaching of these compositions and their methods of making. For the sake of completeness, in some embodiments, M′ is Mo, and M″ is Nb, Ta, Ti, or V, or a combination thereof. In other embodiments, n is 2, M′ is Mo, Ti, V, or a combination thereof, and M″ is Cr, Nb, Ta, Ti, or V, or a combination thereof. In still further embodiments, the empirical formula M′₂M″ₙXₙ₊₁ comprises Mo₂TiC₂, Mo₂VC₂, Mo₂TaC₂, Mo₂NbC₂, Mo₂Ti₂C₃, Cr₂TiC₂, Cr₂VC₂, Cr₂TaC₂, Cr₂NbC₂, Ti₂NbC₂, Ti₂TaC₂, V₂TaC₂, or V₂TiC₂, preferably Mo₂TiC₂, Mo₂VC₂, Mo₂TaC₂, or Mo₂NbC₂, or their nitride or carbonitride analogs. In still other embodiments, M′₂M″ₙXₙ₊₁ comprises Mo₂Ti₂C₃, Mo₂V₂C₃, Mo₂Nb₂C₃, Mo₂Ta₂C₃, Cr₂Ti₂C₃, Cr₂V₂C₃, Cr₂Nb₂C₃, Cr₂Ta₂C₃, Nb₂Ta₂C₃, Ti₂Nb₂C₃, Ti₂Ta₂C₃, V₂Ta₂C₃, V₂Nb₂C₃, or V₂Ti₂C₃, preferably Mo₂Ti₂C₃, Mo₂V₂C₃, Mo₂Nb₂C₃, Mo₂Ta₂C₃, Ti₂Nb₂C₃, Ti₂Ta₂C₃, or V₂Ta₂C₃, or their nitride or carbonitride analogs.

Each of these compositions having empirical crystalline formulae Mₙ₊₁Xₙ or M′₂M″ₙXₙ₊₁ are described in terms of comprising at least one layer having first and second surfaces, each layer comprising a substantially two-dimensional array of crystal cells. In some embodiments, these compositions comprise layers of individual two-dimensional cells. In other embodiments, the compositions comprise a plurality of stacked layers. Additionally, in some embodiments, at least one of said surfaces of each layer has surface terminations (optionally designated “T.sub.s”or “T.sub.x”) comprising alkoxide, carboxylate, halide, hydroxide, hydride, oxide, sub-oxide, nitride, sub-nitride, sulfide, thiol, or a combination thereof. In some embodiments, at least one of said surfaces of each layer has surface terminations comprising alkoxide, fluoride, hydroxide, oxide, sub-oxide, or a combination thereof. In still other embodiments, both surfaces of each layer have said surface terminations comprising alkoxide, fluoride, hydroxide, oxide, sub-oxide, or a combination thereof. As used herein the terms “sub-oxide,” “sub-nitride,” or “sub-sulfide” is intended to connote a composition containing an amount reflecting a sub-stoichiometric or a mixed oxidation state of the M metal at the surface of oxide, nitride, or sulfide, respectively. For example, various forms of titania are known to exist as TiOₓ, where x can be less than 2. Accordingly, the surfaces of the present invention may also contain oxides, nitrides, or sulfides in similar sub-stoichiometric or mixed oxidation state amounts.

Among the family of MXenes, Ti₃C₂Tₓ is particularly well-studied, and for which Ti₃AlC₂ MAX phase can serve as a precursor. Commonly MAX phase is manufactured from pure fine titanium powder. But industry manufacture of MAX phase requires reducing coast of precursors. Alternative types of titanium raw materials can be coarse titanium sponge powder, TiO₂, TiH₂, and TiC.

Hydride titanium (TiH₂) is one source of titanium, and the sinter-ability of TiH₂ powder is higher than that of pure titanium powder and can lead to near 99% of relative density. It was found thermodynamically that the released hydrogen atoms could effectively reduce the titanium oxide existing on the powder surfaces or grain boundaries. Such a self-reduction process by hydrogen atoms makes the grain boundaries very clean with oxide-free condition and helpful for diffusion process during sintering. Studies also demonstrate that the H atoms have the surface cleaning effects in the dehydrogenation process of TiH₂. One study examined the effect of dehydrogenation TiH₂ and ZrH₂ on the intermediate reactions involved in the processes of MAX phase formation.

Some studies have shown that TiH₂ can be used instead of Ti in order to obtain dense aluminum alloys using powder metallurgy (PM) technique. According to these, materials processed from TiH₂ powder demonstrated sintered densities higher with lower oxygen content than those of matching materials processed from Ti powder. Therefore, using TiH₂ as a starting powder can enable the manufacture of titanium PM products with comparatively low impurity content. In sintered alloys, density is increased due to transformations proceeding in TiH2 powder upon vacuum heating and accelerating diffusion. Materials produced using TiH2 powder generally exhibited density 97-99% of theoretical value.

One can use titanium hydride as a low-cost source of titanium for synthesis MAX phase. For example, it was shown that 95 wt% pure Ti₃AlC₂ porous samples was synthesized from an inexpensive powder mixture of TiH₂/1.1Al/2TiC by pressureless sintering (PSL) at 1450° C. for 120 min with a heating rate of 15° C./min without preliminary dehydrogenation of TiH₂. The overall morphology of the sample was porous, and it was also shown that Ti₃C₂ synthesized from such Ti₃AlC₂ was highly oriented and was stable in argon atmosphere at temperature up to 800° C.

Besides depending on precursor content, the density of Ti₃AlC₂ depends on sintering process. Some have synthesized high-purity (97.5%) Ti₃AlC₂ by microwave sintering at 1300° C. using TiH₂/Al/graphite as raw materials. In one work, single-phase dense Ti₃AlC₂ was synthesized by the pulse discharge sintering (PDS) of a powder mixture of TiH₂/Al/TiC without preliminary dehydrogenation. It was noted that dehydrogenation of TiH₂ was rapidly accomplished during the synthesis process at the heating up stage below 800° C. In one study, porous Ti₃AlC₂ ceramics was fabricated by reactive synthesis through TiH₂, Al and graphite powders in a vacuum furnace at temperature from 500 to 1350° C. None, however, have considered the relationship between hydrogen content in a MAX phase and in the MXenes obtained from such precursor.

The present disclosure provides, inter alia, fabrication of Ti₃AlC₂ MAX phase using titanium hydride (TiH₂) as an alternative to Ti metal powder. We demonstrate that the hydrogen trapped in the lattice Ti₃AlC₂ MAX phase during sintering can be retained in Ti₃C₂Tₓ MXene and also substitute carbon in the MXene structure. In this way, a new type of MXenes are disclosed, which one can term x-hydride MXene, e.g., carbohydride Ti₃(CH)₂Tₓ MXene, as an example.

### Experimental

Ti₃AlC₂ MAX Phase Synthesis

Commercial titanium hydride (TiH₂) (125 μm, Pyro Chemical Source LLC), titanium sponge (Tisp) (45-250 μm, Pyro Chemical Source LLC), titanium carbide (TiC) (99.5%, 45 μm, Alfa Aesar, USA) and aluminum (Al) (99.5%, 45 μm, Alfa Aesar, USA) were used as raw materials.

Mixtures TiC/Al/TiH₂, TiC/Al/Tisp and TiC/Al/TiH₂/Tisp were weighed and mixed in the molar ratio 2TiC:2.2Al:1.25Ti for the desired MAX phase synthesis, providing an excess of aluminum (Al—Ti₃AlC₂ MAX). The mixture TiC/Al/TiH₂/Tisp contained 50% TiC, 25% Al and 12.5% Tisp and 12.5% TiH₂ (wt %). The mixing was performed in a ball mill using zirconia beads at 70 rpm for 18 h. A 2:1 mass ratio of zirconia milling beads to the precursor powder mixture was used. The homogeneous mixture was cold pressed in a stainless-steel mold with a pressure of 1000 psi to form a pellet with a 28 mm diameter.

For the synthesis process, pellets were placed in an alumina crucible and put in a tube furnace. The sintering was carried out in a GSL-1700 X tube furnace (MTI Corporation, USA) in flowing argon atmosphere. The tube was purged with Ar at 50mL/min. The furnace was heated to a set temperature at a constant rate of 3° C./min, then was held at the maximum temperature for 2 h. Finally, the samples were cooled down to room temperature in furnace. A mixture of TiC/Al/TiH₂ was sintered at 1380° C., 1400° C., and 1420°C. for 2h. Other mixtures were sintered at 1400° C. The sintered pellets of Ti₃AlC₂ were crushed into powders manually and with a planetary ball mill. For removing impurities, such as intermetallic and oxides, the produced powder was sieved to less than 38 μm particle size and washed in 9 M HCl for 20 h at room temperature while stirring. The HCl washed and dried Ti₃AlC₂ was used to synthesize Ti₃C₂Tₓ.

### MXene Synthesis

Ti₃C₂Tₓ was produced by selective wet-chemical etching. One gram of Ti₃AlC₂ powder was slowly added to 20 mL of etchant and stirred at 300 rpm at 35° C. for 24 h. The etchant was a 6:3:1 mixture (by volume) of 12 M HCl, DI water, and 50 wt. % HF (Acros Organics, Fair Lawn, NJ, USA). Multilayered Ti₃C₂Tₓ MXene was intercalated with LiCl (using 1 g of LiCl per gram of Ti₃AlC₂ MAX) dissolved in 50 mL of DI water and stirred at 300 rpm at room temperature for 24 h. The resulting solution was washed with DI water and centrifuged at 3500 rpm for 5 min. The supernatant was discarded, and the delaminated MXene was redispersed by manual shaking. The washing procedure was repeated until the pH of the mixture was higher than 6. Then, the colloidal solution was centrifuged at 3500 rpm for 60 min, and supernatant containing delaminated Ti₃C₂Tₓ was collected. The MXene free-standing films were prepared from delaminated Ti₃C₂Tₓ by vacuum-assisted filtration.

### Characterization

The phase analysis of MAX and MXene films was carried out by X-ray diffraction (XRD; Miniflex, Rigaku Corporation, Tokyo, Japan) using Cu K_{α} radiation at 40 kV and 15 mA. Step-scan data (with step size equal to 0.02°) were recorded over a range 3-90°(2θ). Conductivity measurements were performed using a four-point probe (Jandel Engineering Ltd., Bedfordshire, UK) on freestanding MXene films. SEM analysis was performed using a Zeiss Supra 50VP electron microscope. UV-Vis spectra were collected using an Evolution 201 spectrometer (Thermo Scientific, MA, USA) with a 10 mm optical length cuvette and scanning from 200 to 1000 nm. Atomic force microscopy (AFM) images were taken with a Bruker Dimension Icon microscope under ambient conditions, operating in Tapping Mode and using TESPA-V2 tips with spring constant, k=42 N/m. Images were captured at scan rate of 1 Hz with 1024 lines per image. The statistical analysis was performed on 100 individual Ti₃C₂Tₓ flakes for each sample. The results were fitted by using a log-normal distribution.

A CAMECA IMS SC Ultra instrument equipped with a cesium gun was used in these experiments. Several modifications of the measurements procedure were applied to ensure the atomic depth resolution, which included high incident angle bombardment (75°), ultra low impact energy (100 eV), in situ ion polishing, optimization of extraction parameters, super cycle, and advanced beam positioning. The exact composition of MAX/MXene sample was determined by applying a devolution and calibration protocol.

Raman spectroscopy was performed using inverted reflection mode Renishaw InVia spectrometer (Gloucestershire, UK). The diode 785 nm laser with 1200 line/mm diffraction grating was used to achieve resonance conditions. The acquisition time was kept at 30 s and the laser power was 5% of 3.59 mW for all the measurement to avoid the laser-induced degradation. Additionally, the 63× objective (NA=0.7) was used.

### Results and Discussion

### Analysis of MAX Produced Using Different Metal Sources

Initial powders TiC and Al were the same for all mixtures. The distinctive feature in the preparation of mixtures was the source of titanium, and Ti sponge and TiH₂ are at present 10 times less expensive than fine Ti. The characteristics of powders are presented in Table 1. TiH₂ XRD pattern due to refinement exhibits FCC Ti (91.0%, a=4.4502 Å) and α-Ti (9.0%) with lattice parameters c=4.6549 Å, a=2.9587 Å. No secondary phases were found.

Titanium hydride is often designated as TiH₂ because hydrogen can theoretically saturate titanium to 4 wt % or 66 at %. Typically, hydrogen exists over a wide content range of 3-4 wt %. When titanium hydrides are heated at 300-400° C., the release of hydrogen begins. However, dehydrogenation does not occur completely even at high temperatures of 1000-1200 ° C.²⁹. The dehydrogenation process is accompanied by intense sintering. The strength and density of the resulting sinter is determined mainly by temperature, heating rate and isothermal holding time.

Employing Ti sponge as a precursor allows the synthesis of pure Ti₃AlC₂ MAX phase with high porosity (about 70%). Therefore, in order to increase the porosity of MAX, we replaced 50% wt. TiH₂ powder as a source of hydrogen with Ti sponge powder in ratio 50:50.

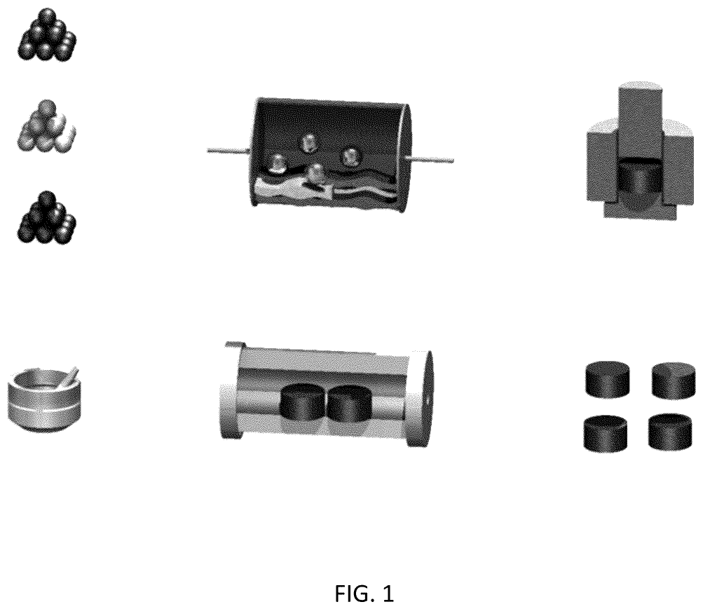

The powder mixtures were pressed into pellets, which ensures closer contact between the components and accelerates diffusion processes during sintering. Moreover, the release of hydrogen from the pellet is even easier than from bulk materials since it proceeds mostly in the condition of open porosity. The technological flow chart is shown in FIG. 1.

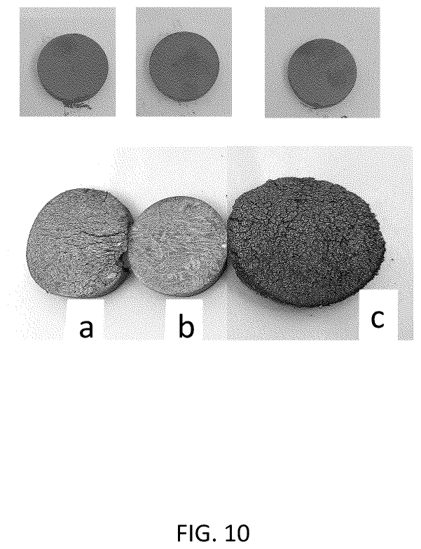

All samples with TiH₂ powders shrank after sintering, regardless of temperature. Samples with Ti sponge had the most porosity (about 70%), samples TiH₂/Tisp had about 27% and the least porosity was observed with TiH₂ MAX (about 17%). Sintered pellets after MAX synthesis are represented in FIG. 10.

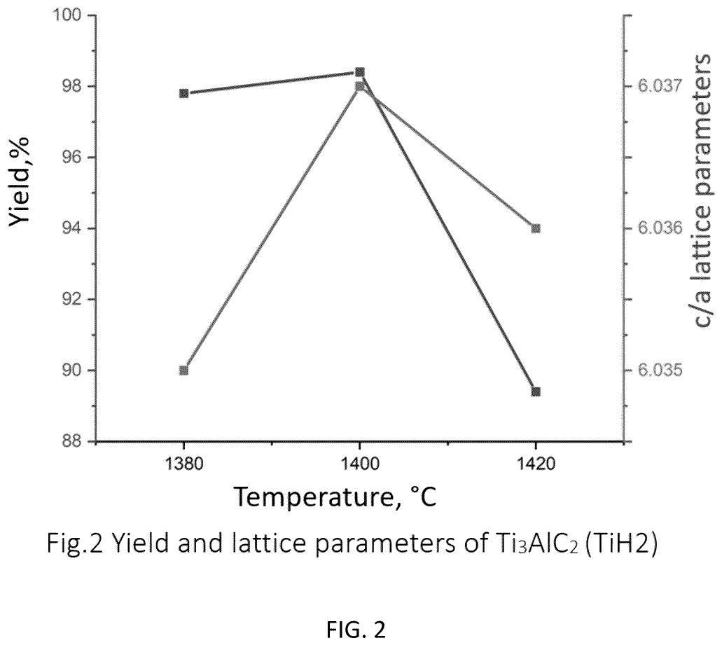

Lattice parameters and compositions for experimental samples with TiH₂ sintered at 1380, 1400 1420° C. are reported. For MAX sintered at 1400° C., the lattice parameter ratio c/a was the largest 6.037 (FIG. 2) but less than for Ti₃AlC₂ MAX phase with fine Ti (c/a=6.0426). The change in the lattice parameter for samples with TiH₂ is explained by the presence of hydrogen in the lattice, suggesting that they contained less oxygen in the MAX phase lattice. Also the yield for this samples was the highest (98% Ti₃AlC₂ MAX phase) so this temperature was optimal and MXenes were synthesized from that MAX. Impurities TiAl₃ and Al₂O₃ in all samples are not significant and can be removed during HCl washing, HCl/HF etching of MAX phases.

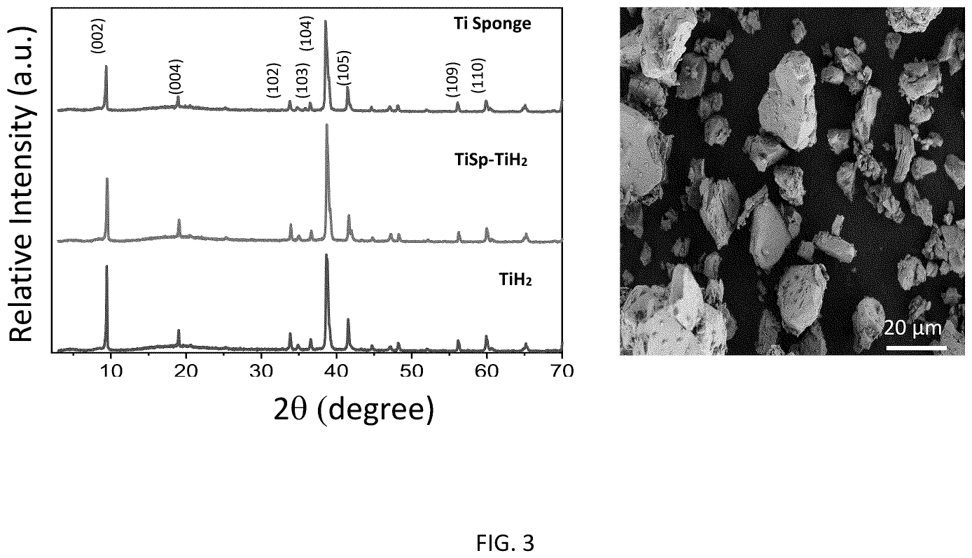

SEM images of Ti₃AlC₂ MAX suggest that layered Ti₃AlC₂ MAX phases were obtained from these mixtures. FIG. 3 shows SEM images of Ti₃AlC₂ for samples with TiH₂ sintered at 1400° C. The success of the MAX synthesis was confirmed by the XRD (FIG. 3). For all samples, peaks expected for the p63/mmc MAX phase structure are observed. No peaks related to the Ti₂AlC phase or TiC were fixed for all samples. An intermetallic compound, TiAl₃, which can be easily removed by HCl washing at room temperature, was present in the samples.

### Analysis of MXenes

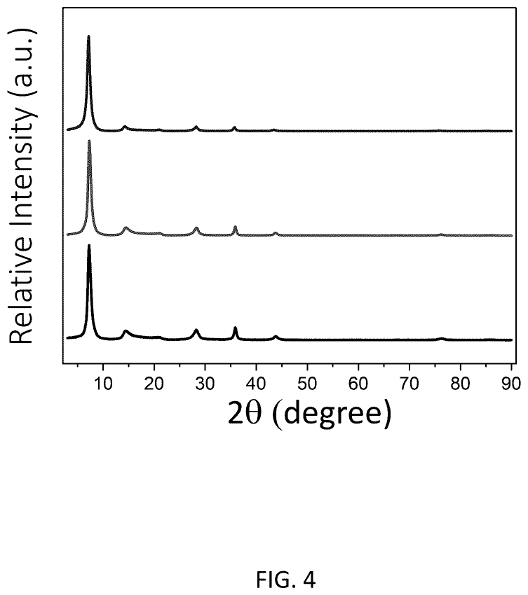

The XRD measurements of single layer Ti₃C₂Tₓ films (FIG. 4) show that after etching in HF/HCl/H₂O mixture the Al layer was completely removed from the MAX phases and this led to the disappearance of all the Ti₃AlC₂ related peaks. The (002) peak was shifted toward lower values, from 2θ=9.57°to 7.13°, highlighting the successful formation of MXene. All other peaks for both samples are at the same 2θ values.

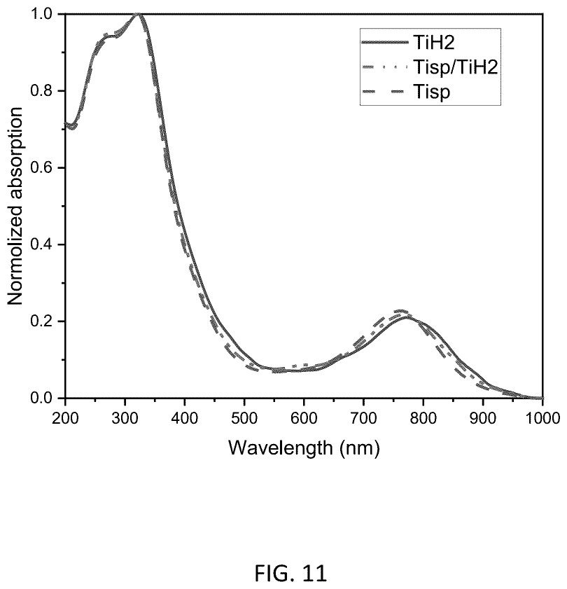

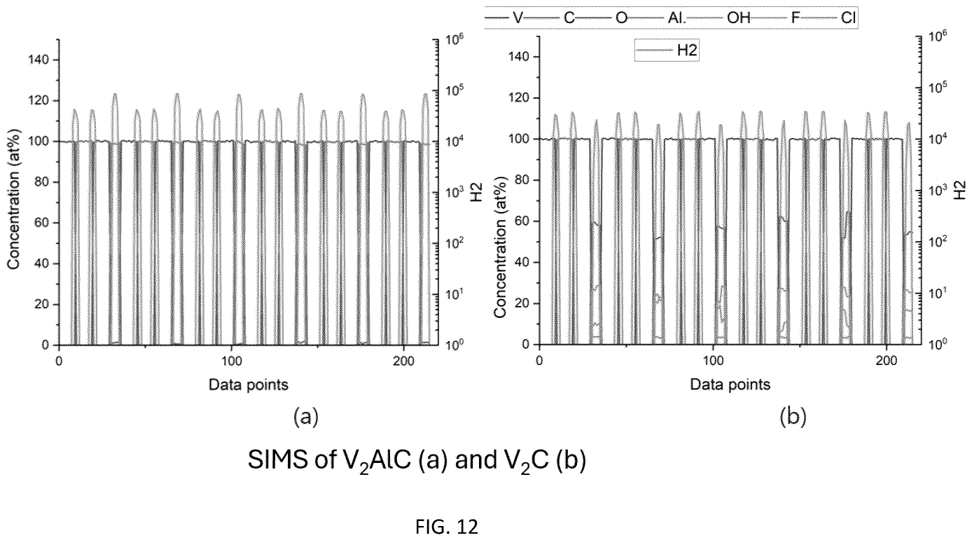

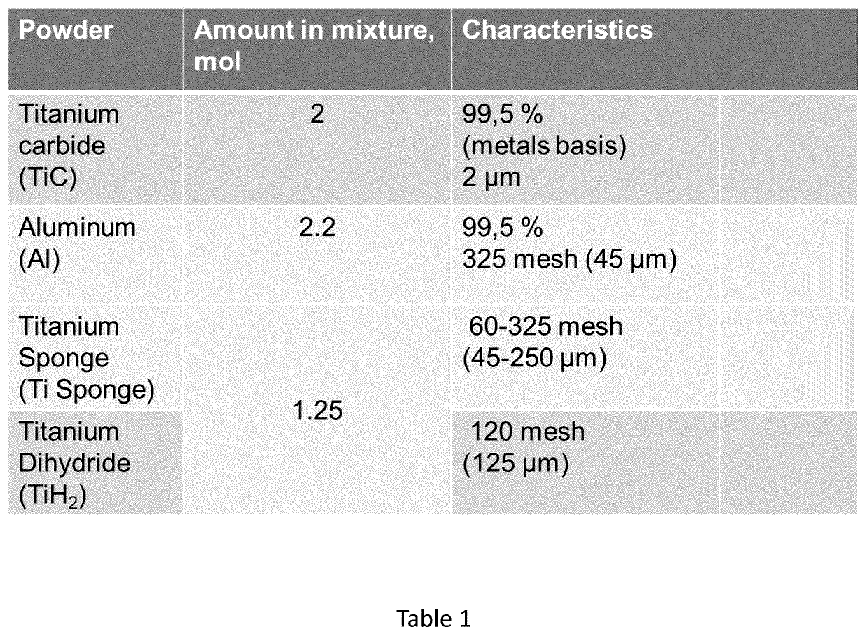

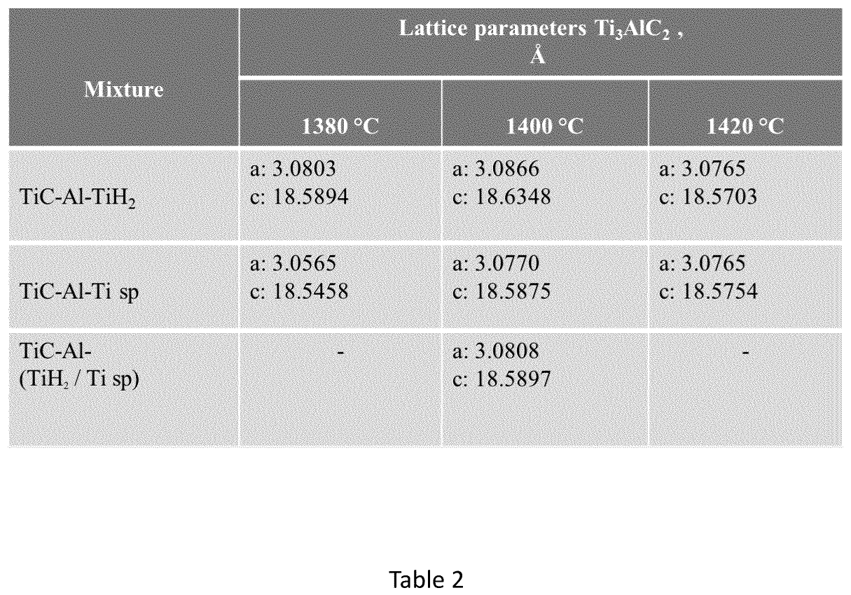

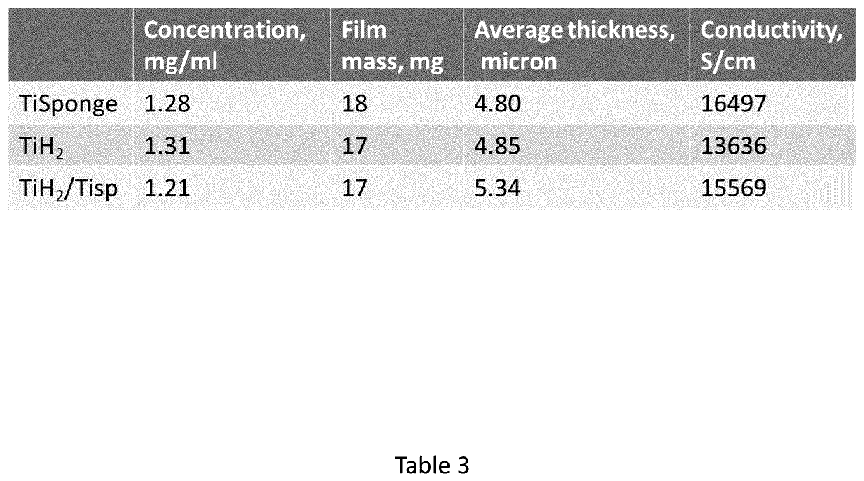

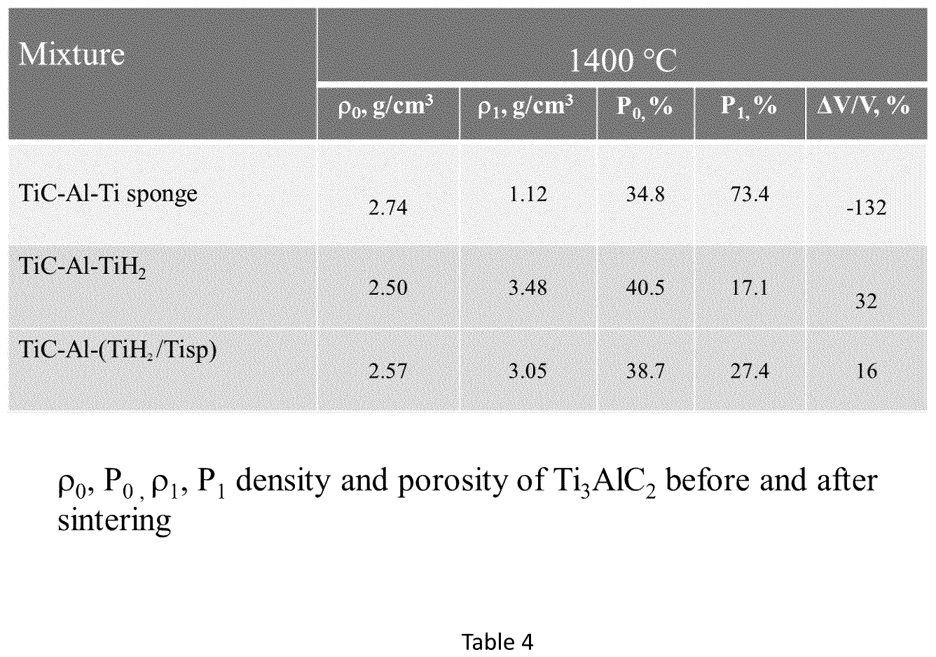

Stability studies were performed after synthesis, by diluting each delaminated MXene solution. The UV—visible spectroscopy measurements (FIG. 11) showed a broad absorption peak at 760 nm for samples with Ti sponge and small shift to 770 nm for samples with TiH₂, which belongs to Ti₃C₂Tₓ, confirming the good stability of MXenes.

Four-point probe measurements of vacuum-filtered films showed that the electrical conductivity of Ti₃C₂Tₓ obtained from Ti sponge MAX/MXene reached ˜16,500 S/cm, whereas the MXene films obtained from TiH₂ MAX showed lower conductivity ˜of 13,636 S/cm and TiH₂/Tisp MAX ˜of 15,569 S/cm (Table 3). This can be explained by the larger flake size for Ti₃C₂Tₓ from the Ti sponge MAX phases, even though a decreased concentration of defects and other factors may also contribute to a MXene's electrical properties.

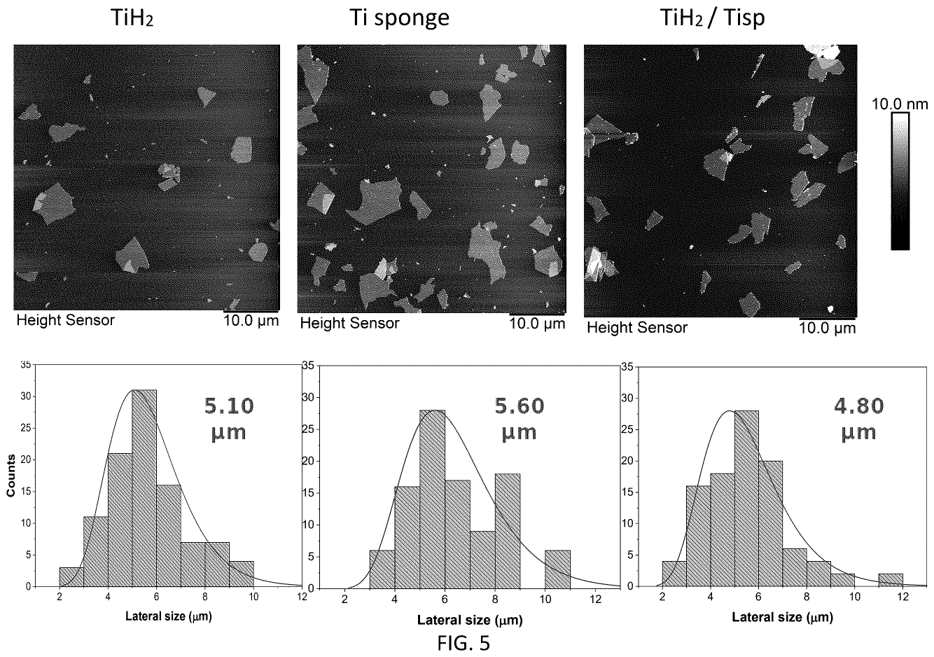

Quality of MXenes can depend on the purity and crystal size of the MAX phase. One of the important characteristics of MXenes is their flake size. FIG. 5 shows the AFM statistical analysis of delaminated Ti₃C₂Tₓ samples along with their flake size distribution obtained by mapping over 100 individual flakes. The average lateral size of Ti₃C₂Tₓ flakes from Ti sponge MAX is comparatively larger (5.60 μm, FIG. 5) than flakes from TiH₂ MAX (5.10μm) and TiH₂/Tisp MAX (4.80 μm).

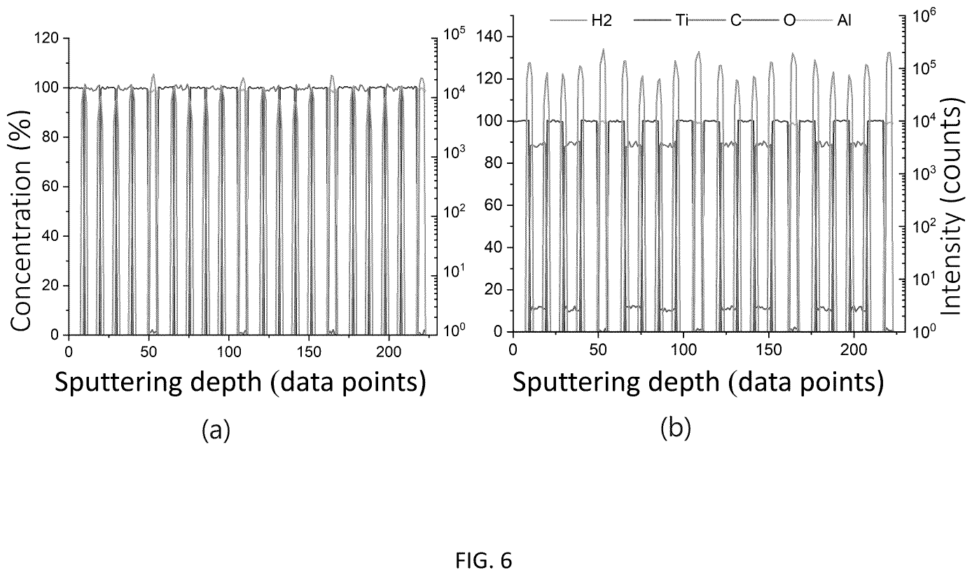

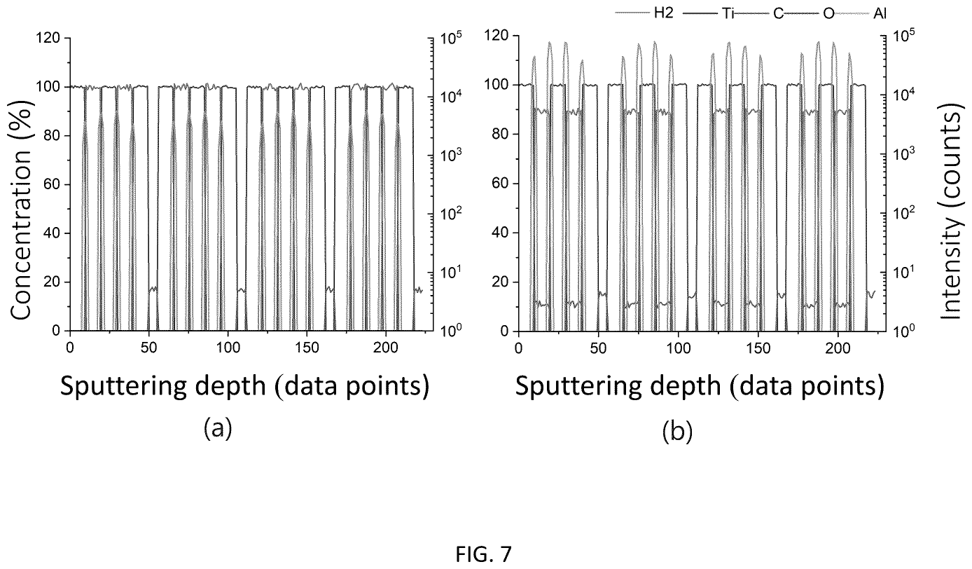

In order to determine presence of hydrogen in the structure of MAX and MXenes and concentration of oxygen, SIMS analysis was carried out (FIGS. 6-7). Hydrogen occupied inside of TiC and Al layers for both MAX samples so H comes from TiH₂. Moreover, we detected hydrogen signal for MXenes obtained from these MAX. The intensity of hydrogen signal for MXenes obtained with TiH₂/Tisponge was higher.

SIMS measurements shows that up to 1% oxygen is located in the Al layer in both MAX samples. However for MAX with TiH₂/Tisponge oxygen is presents in carbon layer (˜15%) yet and forms oxycarbide. For MXenes this trend continues. Oxygen is present between TiC layers (for both MAX) and in the carbon layer for MXenes obtained with TiH₂/Tisponge.

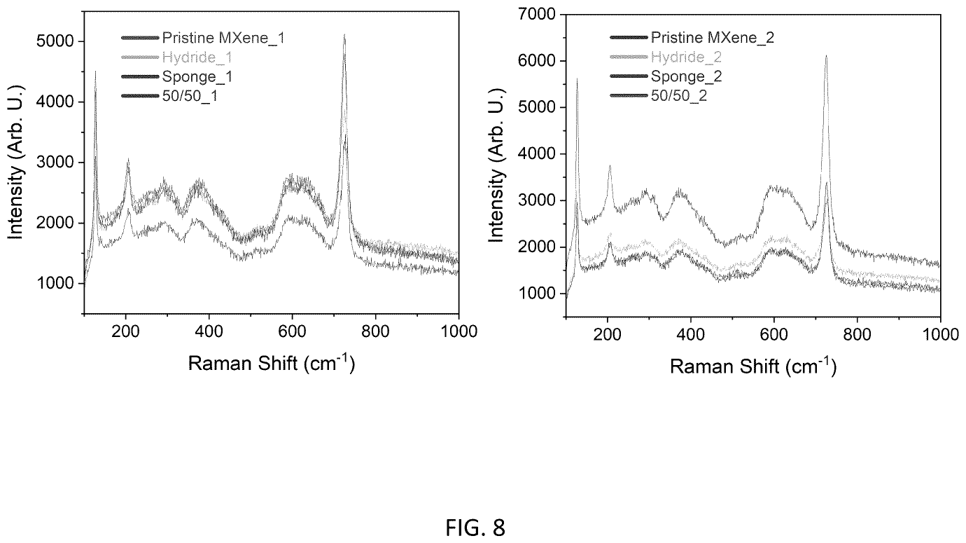

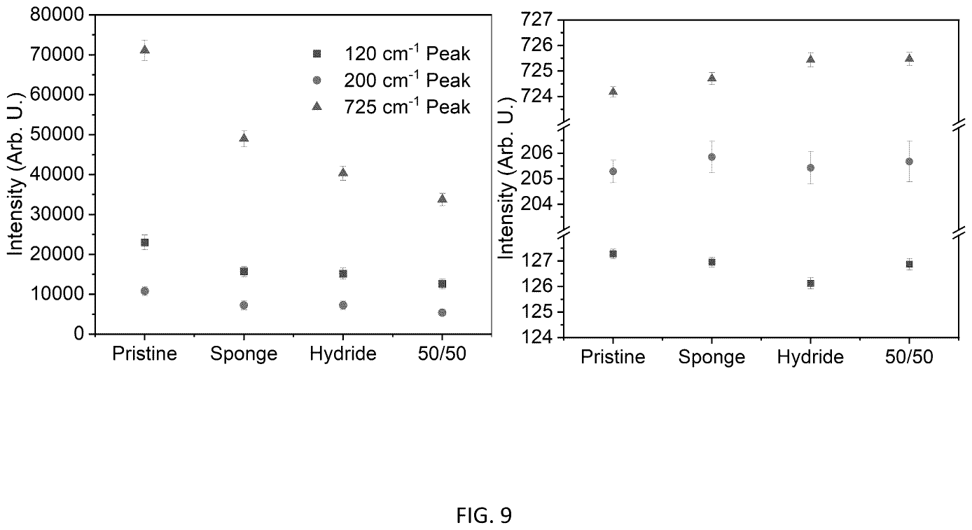

Raman spectroscopy for all analyzed MXenes showed the typical Raman spectra in the fingerprint region (FIG. 8). The highest observed peaks at ˜120 cm⁻¹ and 200 cm⁻¹ correspond to in-plane vibrations and out-of-plane vibrations of the whole MXene flake, respectively, and 725 cm⁻¹ peak corresponds to out-of-plane vibrations of carbon layers. Because the rest of the vibrations are broad features largely affected by heterogeneous surface terminations, we used three peaks with largest intensities to look at the differences in MXene terminations. Across all three vibrations, corresponding to 120 cm⁻¹, 200 cm⁻¹ and 785 cm⁻¹ peaks, the intensity decreases from MXene made out of the regular MAX phase to sponge to hydride and the 50/50 mixture (FIG. 9). The overall intensity goes down with the increase in defects, and since SEM shows larger particles for sponge materials, this observed trend could be ascribed to the smaller flakes in hydride and mixture leading to the increased ratio of flake edges to basal planes, and therefore defects.

Additionally, a clear increase in A_{1g}(C) mode at 725 cm⁻¹ is observed for regular MXene→Ti sponge MXene→TiH₂ MXene→mixture. It has been shown that larger interlayer spacing leads to an increase in 725 cm⁻⁻¹ peak position, and because the XRD of the disclosed materials shows the same 2θ values, the origin of this trend may derive from changes in surface terminations, which was observed in multiple in situ spectroelectrochemical works as well as theoretical predictions. The potential increase in oxygen terminations leads to larger frequencies of this 725 cm⁻¹ peak vibration. From computational work, it is evident that the increase in oxygen terminations would also lead to 120 cm⁻¹ shifting to lower frequencies, which one can observe with hydride MXene material.

### Conclusion

As described, a MAX phase (such as Ti₃AlC₂) can be synthesized employing low-cost TiH₂ as source of the metal, e.g., Ti. Further, implementation of hydride in the lattice of MAX phase allows one synthesize new types of MXenes which we term here x-hydride MXenes, e.g., carbohydride Ti₃(CH)₂Tₓ MXenes or nitrohydride MXenes.

### Aspects

The following Aspects are illustrative only and do not limit the scope of the present disclosure or the appended claims. Any part or parts of any one or more Aspects can be combined with any part or parts of any one or more other Aspects.

Aspect 1. A x-hydride MXene, comprising: a MXene material,
the MXene material having the formula Mₙ₊₁(XH)ₙTₓ, wherein M is an early transition metal, X is C and/or N, and T is a surface termination. As described elsewhere herein, X can be H and/or C.

The subscript n can be an integer; for example, n can be 1, 2, 3, 4, or 5, preferably 1, 2, or 3.

Example x-hydride MXenes include, without limitation, Scₙ₊₁(CH)ₙTₓ, Yₙ₊₁(CH)ₙTₓ, Luₙ₊₁(CH)ₙTₓ, Tiₙ₊₁(CH)ₙTₓ, Zrₙ₊₁(CH)ₙTₓ, Hfₙ₊₁(CH)ₙTₓ, Vₙ₊₁(CH)ₙTₓ, Nbₙ₊₁(CH)ₙTₓ, Taₙ₊₁(CH)ₙTₓ, Crₙ₊₁(CH)nTₓ, Moₙ₊₁(CH)ₙTₓ, or Wₙ₊₁(CH)ₙTₓ, as but some examples. Other example x-hydride MXenes include, without limitation, Scₙ₊₁(NH)ₙTₓ, Yₙ₊₁(NH)ₙTₓ, Luₙ₊₁(NH)ₙTₓ, Tiₙ₊₁(NH)ₙTₓ, Zrₙ₊₁(NH)ₙTₓ, Hfₙ₊₁(NH)ₙTₓ, Vₙ₊₁(NH)ₙTₓ, Nbₙ₊₁(NH)ₙTₓ, Taₙ₊₁(NH)ₙTₓ, Crₙ₊₁(NH)nTₓ, Moₙ₊₁(NH)ₙTₓ, or Wₙ₊₁(NH)ₙTₓ, as but some examples.

Aspect 2. The composition of Aspect 1, where M is at least one of Sc, Y, Lu, Ti, Zr, Hf, V, Nb, Ta, Cr, Mo, or W. Ti is particularly preferred, but is not a requirement.

Aspect 3. The composition of any one of Aspects 1-2, wherein X is C.

Aspect 4. The composition of any one of Aspects 1-2, wherein X is N.

Aspect 5. The composition of any one of Aspects 1-4, wherein T is —O, —OH, or —F. In some embodiments, hydride terminations can be present.
Aspect 6. A composition, comprising: a MAX-phase material, the MAX-phase material comprising an amount of hydrogen therein. A MAX phase material can be a ternary carbide or nitrides with the general formula:

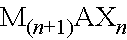

where:
M=an early transition metal (e.g., Ti, V, Cr)
A=an element from groups 13-16 (e.g., Al, Si)
X=carbon and/or nitrogen
n=an integer (such as 1, 2, or 3), which can determine the thickness of the layers. The foregoing MAX-phase materials can include an amount of hydrogen therein.

Aspect 7. The composition of Aspect 6, wherein the MAX-phase material comprises Ti, Al, and C.

Aspect 8. A method for forming a x-hydride MXene, comprising:
removing the A-element from a MAX-phase material that comprises an amount of hydrogen therein, the removing being performed under conditions sufficient to give rise to an x-hydride MXene.

Such an x-hydride MXene can be according to the present disclosure, such as according to any one of Aspects 1-5. As described elsewhere herein, an x-hydride MXene can be formed from a starting material that includes a first MAX-phase material and a second material, the second material including an amount of hydride therein. A MAX-phase material according to the present disclosure can be formed, for example, from titanium, and Ti sponge and TiH₂.

Aspect 9. The method of Aspect 8, wherein the MAX phase material comprises Ti.

Aspect 10. The method of any one of Aspects 8-9, wherein the x-hydride MXene comprises Ti₃(CH)₂Tₓ.

What is claimed:

1. A x-hydride MXene, comprising:
a MXene material,
the MXene material having the formula Mₙ₊₁(XH)ₙTₓ, wherein M is an early transition metal, X is C and/or N, and T is a surface termination.

2. The composition of claim 1, where M is at least one of Sc, Y, Lu, Ti, Zr, Hf, V, Nb, Ta, Cr, Mo, or W.

3. The composition of claim 1 wherein X is C.

4. The composition of claim 1, wherein X is N.

5. The composition of claim 1, wherein T is —O, —OOH, or —OF.

6. A composition, comprising:
a MAX-phase material, the MAX-phase material comprising an amount of hydrogen therein.

7. The composition of claim 6, wherein the MAX-phase material comprises Ti, Al, and C.

8. A method for forming a carbohydride MXene, comprising:
removing the A-element from a MAX-phase material that comprises an amount of hydrogen therein,
the removing being performed under conditions sufficient to give rise to an x-hydride MXene.

9. The method of claim 8, wherein the MAX phase material comprises Ti.

10. The method of claim 8, wherein the x-hydride MXene comprises Ti₃(CH)₂Tₓ.
